(19) United States
(12) Patent Application Publication
(10) Pub. No.: US 2025/0298729 A1
(43) Pub. Date: Sep. 25, 2025

(54) MACHINE LEARNING-BASED TEST GENERATION AND CONTROL

(71) Applicant: Dell Products L.P., Round Rock, TX (US)

(72) Inventors: Osnat Shasha, Holon (IL); Alex Kulakovsky, Ra'anana (IL); Shay Katz, Alon-Shvut (IL)

(21) Appl. No.: 18/609,401

(22) Filed: Mar. 19, 2024

(51) Int. Cl. G06F 11/36

(52) U.S. Cl. CPC G06F 11/3688; G06F 11/3684

(57) ABSTRACT

An apparatus comprises at least one processing device configured to generate a first data structure by parsing a request to generate a given test scenario for testing of an information technology asset, and to process the first data structure utilizing a machine learning model to generate a second data structure comprising a given sequence of test steps for the given test scenario. The at least one processing device is also configured to map the given sequence of test steps in the second data structure to respective application programming interface calls of a test automation framework each associated with a functional code test unit of a test code database of the test automation framework. The at least one processing device is further configured to execute the given test scenario utilizing the mapped application programming interface calls of the test automation framework.

### BACKGROUND

Support platforms may be utilized to provide various services for sets of managed computing devices. Such services may include, for example, troubleshooting and remediation of issues encountered on computing devices managed by a support platform. This may include periodically collecting information on the state of the managed computing devices, and using such information for troubleshooting and remediation of the issues. Such troubleshooting and remediation may include receiving requests to provide servicing of hardware and software components of computing devices. For example, users of computing devices may submit service requests to a support platform to troubleshoot and remediate issues with hardware and software components of computing devices. Such requests may be for servicing under a warranty or other type of service contract offered by the support platform to users of the computing devices. Support platforms may also provide functionality for testing managed computing devices.

### SUMMARY

Illustrative embodiments of the present disclosure provide techniques for machine-learning based generation and execution of test scenarios.

In one embodiment, an apparatus comprises at least one processing device comprising a processor coupled to a memory. The at least one processing device is configured to generate a first data structure by parsing a request to generate a given test scenario for testing of an information technology asset, and to process the first data structure utilizing a machine learning model to generate a second data structure, the second data structure comprising a given sequence of test steps for the given test scenario. The at least one processing device is also configured to map the given sequence of test steps in the second data structure to respective application programming interface calls of a test automation framework, each of the application programming interface calls being associated with a functional code test unit of a test code database of the test automation framework. The at least one processing device is further configured to execute the given test scenario utilizing the mapped application programming interface calls of the test automation framework.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine-learning based generation of test scenarios in an illustrative embodiment.

FIG. 2 is a flow diagram of an exemplary process for machine-learning based generation of test scenarios in an illustrative embodiment.

FIG. 3 shows a system configured for generation of test scenarios utilizing a large language model in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

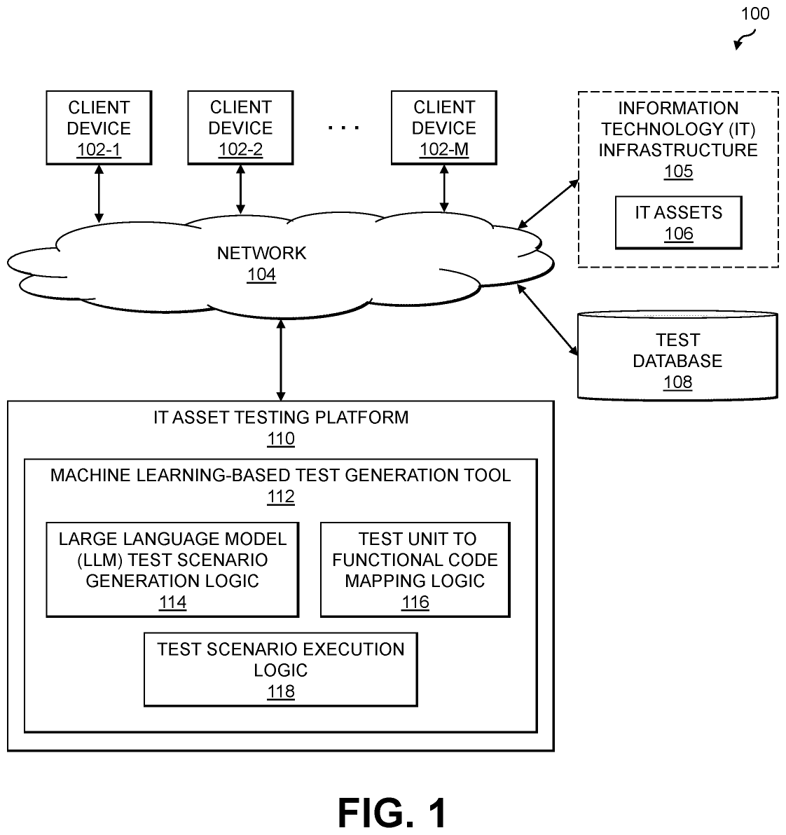

FIG. 1 shows an information processing system 100 configured in accordance with an illustrative embodiment. The information processing system 100 is assumed to be built on at least one processing platform and provides functionality for machine-learning based generation of test scenarios. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a test database 108, and an IT asset testing platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the IT asset testing platform 110 is used for an enterprise system. For example, an enterprise may subscribe to or otherwise utilize the IT asset testing platform 110 for managing IT assets that are developed or operated by that enterprise (e.g., software or hardware IT assets such as the IT assets 106 of the IT infrastructure 105). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The test database 108 is configured to store and record various information that is utilized by the IT asset testing platform 110. Such information may include, for example, information that is collected regarding historical test scenarios or test cases used in testing of IT assets, where such information may include test steps used in the test scenarios, mapping of the test scenarios and test steps to actual test unit functional code, machine learning model (e.g., large language model (LLM)) configurations for machine learning models (e.g., LLMs) used for generating test scenarios, etc. The test database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the IT asset testing platform 110, as well as to support communication between the IT asset testing platform 110 and other related systems and devices not explicitly shown.

The IT asset testing platform 110 may be provided as a cloud service that is accessible by one or more of the client devices 102 to allow users thereof to manage development and deployment of IT assets (e.g., the IT assets 106 of the IT infrastructure 105). The client devices 102 may be configured to access or otherwise utilize the IT asset testing platform 110 (e.g., to create, develop and refine test scenarios for use in evaluating IT assets 106, such as software code that has been or will be deployed on one or more of the IT assets 106, etc.). In some embodiments, the client devices 102 are assumed to be associated with test developers, system administrators, IT managers or other authorized personnel responsible for managing testing of IT assets for an enterprise. In some embodiments, the IT assets 106 of the IT infrastructure 105 are owned or operated by the same enterprise that operates the IT asset testing platform 110. In other embodiments, the IT assets 106 of the IT infrastructure 105 may be owned or operated by one or more enterprises different than the enterprise which operates the IT asset testing platform 110 (e.g., a first enterprise provides support for multiple different customers, businesses, etc.). Various other examples are possible.

In some embodiments, the client devices 102 and/or the IT assets 106 of the IT infrastructure 105 may implement host agents that are configured for automated transmission of information with the IT asset testing platform 110 regarding development of a particular application or other piece of software and/or hardware of an IT asset such as one of the IT assets 106, including the development of test scenarios for the IT assets 106. It should be noted that a “host agent” as this term is generally used herein may comprise an automated entity, such as a software entity running on a processing device. Accordingly, a host agent need not be a human entity.

The IT asset testing platform 110 in the FIG. 1 embodiment is assumed to be implemented using at least one processing device. Each such processing device generally comprises at least one processor and an associated memory, and implements one or more functional modules or logic for controlling certain features of the IT asset testing platform 110. In the FIG. 1 embodiment, the IT asset testing platform 110 implements a machine learning-based test generation tool 112. The machine learning-based test generation tool 112 comprises LLM test scenario generation logic 114, test unit to functional code mapping logic 116 and test scenario execution logic 118. The machine learning-based test generation tool 112 is configured to generate a first data structure by parsing a request to generate a given test scenario for testing of an IT asset (e.g., one of the IT assets 106). The LLM test scenario generation logic 114 is configured to process the first data structure utilizing a machine learning model (e.g., an LLM) to generate a second data structure, the second data structure comprising a given sequence of test steps for the given test scenario. The test unit to functional code mapping logic 116 is configured to map the given sequence of test steps in the second data structure to respective API calls of a test automation framework, each of the API calls being associated with a functional code test unit of a test code database (e.g., test database 108) associated with the test automation framework. The test scenario execution logic 118 is configured to execute the given test scenario utilizing the mapped API calls of the test automation framework.

At least portions of the machine learning-based test generation tool 112, the LLM test scenario generation logic 114, the test unit to functional code mapping logic 116 and the test scenario execution logic 118 may be implemented at least in part in the form of software that is stored in memory and executed by a processor.

It is to be appreciated that the particular arrangement of the client devices 102, the IT infrastructure 105, the test database 108 and the IT asset testing platform 110 illustrated in the FIG. 1 embodiment is presented by way of example only, and alternative arrangements can be used in other embodiments. As discussed above, for example, the IT asset testing platform 110 (or portions of components thereof, such as one or more of the machine learning-based test generation tool 112, the LLM test scenario generation logic 114, the test unit to functional code mapping logic 116 and the test scenario execution logic 118) may in some embodiments be implemented internal to the IT infrastructure 105.

The IT asset testing platform 110 and other portions of the information processing system 100, as will be described in further detail below, may be part of cloud infrastructure.

The IT asset testing platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the test database 108 and the IT asset testing platform 110 or components thereof (e.g., the machine learning-based test generation tool 112, the LLM test scenario generation logic 114, the test unit to functional code mapping logic 116 and the test scenario execution logic 118) may be implemented on respective distinct processing platforms, although numerous other arrangements are possible. For example, in some embodiments at least portions of the IT asset testing platform 110 and one or more of the client devices 102, the IT infrastructure 105, the IT assets 106 and/or the test database 108 are implemented on the same processing platform. A given client device (e.g., 102-1) can therefore be implemented at least in part within at least one processing platform that implements at least a portion of the IT asset testing platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the test database 108 and the IT asset testing platform 110, or portions or components thereof, to reside in different data centers. Numerous other distributed implementations are possible. The IT asset testing platform 110 can also be implemented in a distributed manner across multiple data centers.

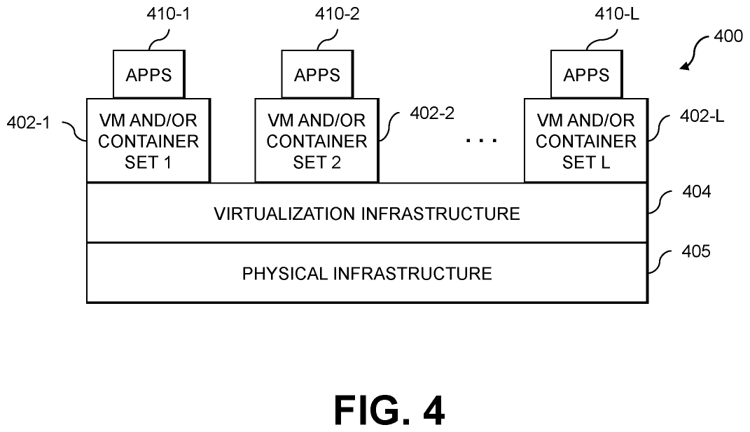

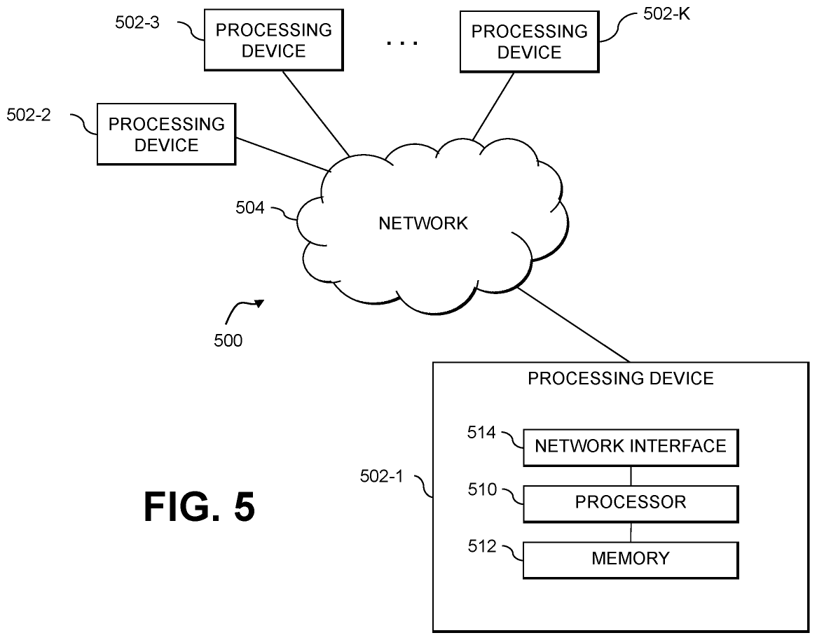

Additional examples of processing platforms utilized to implement the IT asset testing platform 110 and other components of the information processing system 100 in illustrative embodiments will be described in more detail below in conjunction with FIGS. 4 and 5.

It is to be understood that the particular set of elements shown in FIG. 1 for machine-learning based generation of test scenarios is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

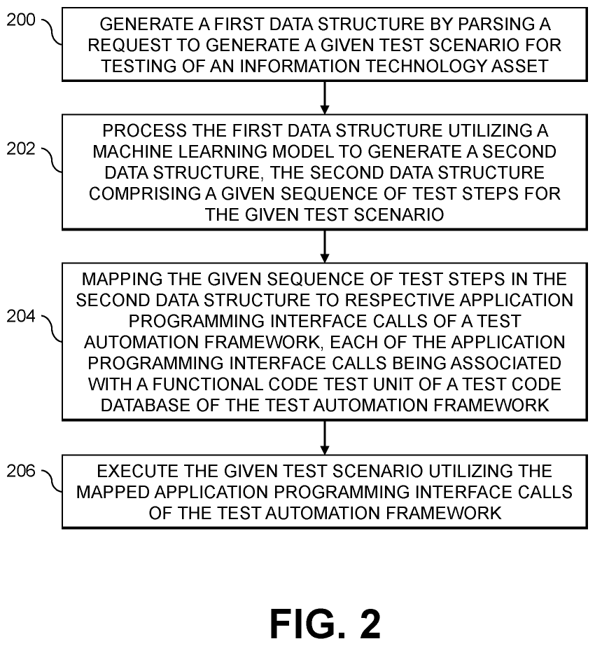

An exemplary process for machine-learning based generation of test scenarios will now be described in more detail with reference to the flow diagram of FIG. 2. It is to be understood that this particular process is only an example, and that additional or alternative processes for machine-learning based generation of test scenarios may be used in other embodiments.

In this embodiment, the process includes steps 200 through 206. These steps are assumed to be performed by the IT asset testing platform 110 utilizing the machine learning-based test generation tool 112, the LLM test scenario generation logic 114, the test unit to functional code mapping logic 116 and the test scenario execution logic 118. The process begins with step 200, generating a first data structure by parsing a request to generate a given test scenario for testing of an IT asset. The request to generate the given test scenario may comprise a natural language description of a testing goal for the given test scenario. In step 202, the first data structure is processed utilizing a machine learning model (e.g., an LLM) to generate a second data structure, the second data structure comprising a given sequence of test steps for the given test scenario. In step 204, the given sequence of test steps in the second data structure are mapped to respective API calls of a test automation framework, each of the API calls being associated with a functional code test unit of a test code database of the test automation framework. At least a given one of the API calls of the test automation framework associated with a given functional code test unit may comprise at least one of a validation and a verification of a given one of the test steps to be performed at least one of prior to and subsequent to execution of the given functional code test unit. In step 206, the given test scenario is executed utilizing the mapped API calls of the test automation framework.

In some embodiments, step 200 includes selection of one or more test steps from a test management environment comprising a repository of one or more existing test scenarios and associated test steps. Step 200 may also or alternatively include selecting at least one of one or more existing test scenarios from a repository of the test management environment. Step 202 may comprise utilizing the selected at least one existing test scenario for adapting the machine learning model to a testing context of the selected at least one existing test scenario.

Step 202 may comprise generating two or more different sequences of test steps as alternatives for the given test scenario. Generating the second data structure may comprise presenting the two or more different sequences of test steps to a source of the request to generate the given test scenario, selecting one of the two or more different sequences of test steps based at least in part on feedback received from the source of the request to generate the given test scenario, and adding the selected one of the two or more different sequences of test steps as the given sequence of test steps in the second data structure. Generating the second data structure may further comprise determining a ranking of the two or more different sequences of test steps and providing the determined ranking of the two or more different sequences of test steps to the source of the request to generate the given test scenario. The ranking of the two or more different sequences of test steps may be determined based at least in part on frequencies of use of test steps in the two or more different sequences of test steps in a set of one or more existing test scenarios of a test management environment.

In some embodiments, the second data structure further comprises specification of one or more test bed characteristics of a test bed to be utilized for executing the given test scenario. The one or more test bed characteristics may comprise at least one of a hardware and a software configuration for the test bed to be utilized for executing the given test scenario. The one or more test bed characteristics may also or alternatively comprise one or more workloads to run on the test bed during execution of the given test scenario.

It should be noted that the term “data structure” as used herein is intended to be broadly construed. A data structure, such as any single one of or combination of the first and second data structures referred to above, may provide a portion of a larger data structure, or any one of or combination of the first and second data structures may be combinations of multiple smaller data structures. Therefore, the first and second data structures referred to above may be different parts of a same overall data structure, or one or more of the first and second data structures could be made up of multiple smaller data structures. The data structures may include tables, vectors, embeddings, or various other data structures. In some embodiments, the data structures are specifically formatted or generated such that they are suitable for use as input to machine learning model.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for generating different test scenarios, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

In complex, high-scale projects, the development, administration, execution and monitoring of testing occurs across multiple tools and environments. Diverse experts with various testing skills and domain skills are essential for developing test frameworks and coding new test scenarios. This complexity adds intricacy to the processing, becoming a bottleneck for quality assurance (QA) teams in the context of significant projects. QA engineers write test cases or test scenarios to ensure that a product (e.g., a software or hardware IT asset) works as expected, with the test cases or test scenarios being maintained in a test management environment. The test management environment provides a repository for persisting test scenarios and test steps. A test scenario is used to test functionality of a product, and includes a collective set of test steps in a pre-defined order. A test step includes a description of a small test unit that can be used by various test scenarios. Examples of test steps include “rest server X,” “disconnect cable Y,” “verify the power is on,” etc. A test automation framework provides a common infrastructure for coding, organizing and executing test scenarios. New tests are added to the test automation framework and are kept in a database. Test step functional units are coded test steps used by the test automation framework, where test step functional units are mapped to test steps, and a collection of test step functional units may be used to create a test scenario.

Test steps (e.g., small test units) and test scenarios (e.g., an ordered set of test steps) may be specifically coded by QA engineers and added to a test automation framework and kept in a test code database. This coding, in conventional approaches, is a time-consuming manual process that requires knowledge and experience in the test automation framework and test coding. As a result, it limits test coding ability to a small group of QA engineers with the necessary skill set. This heavy reliance on a dedicated QA engineering team often creates bottlenecks on delivering extensive test coverage for new features in complex IT assets, affecting code quality and delivery times.

Illustrative embodiments provide technical solutions for utilizing large language models (LLMs) to generate new test scenarios by processing test steps written in plain English, and for adding the generated new test scenarios to a test management environment and generating testing code for the generated new test scenarios as an output. In some embodiments, existing test steps and test scenarios are maintained in the test management environment, where each existing test unit (e.g., a test step) may be mapped to a corresponding coded test unit in a test automation framework that can be used as a reference. The technical solutions enable generation of new test scenarios and testing code for the new test scenarios without requiring manual effort of QA engineers with advanced skill sets, and instead utilize simple instructions provided to a suitable trained and fine-tuned LLM.

In some embodiments, the LLM is trained by using sets of test steps and test scenarios, and their respective coded test unit functions in a test automation framework that can be used as a reference. The LLM is further tuned to propose a correct order of test units and to find gaps in test scenarios by proposing, for example, specific test beds for execution of test scenarios. The technical solutions described herein enable a clearer separation between the technical aspects of coding testing infrastructure capabilities and writing up actual test scenarios. Advantageously, the technical solutions allow anyone to add new test scenarios to a test automation framework using plain human language without knowing or understanding any of the underlying QA infrastructure (e.g., a test management environment and/or a test automation framework).

In some embodiments, the LLM is fine-tuned to act as an adapter layer between a test management environment and a test automation framework. Implementing such a system reduces the dependency on qualified QA engineers to code new test scenarios, and also reduces costs and test scenario preparation time. The fine-tuned LLM system is advantageously able to translate a description of a test scenario to be generated, which is provided as a prompt in plain human language, into a new test scenario (e.g., an ordered sequence of test units). The new test scenarios generated by the fine-tuned LLM are persisted automatically in a test management environment. The fine-tuned LLM system is also advantageously able to map test steps in the generated new test scenarios to respective coded test unit function application programming interfaces (APIs), and to generate respective coded test unit functions and persist them in a test automation framework. The fine-tuned LLM system is thus able to create a coded test unit function API and map it to a test unit for future use. The fine-tuned LLM system is further advantageously able to propose or recommend a more precise test order (e.g., of test units for a test scenario), and to find gaps in test scenarios and propose more efficient test scenarios (e.g., validations, test beds, etc.). The fine-tuned LLM system in some embodiments is able to propose or recommend several test scenarios, with ranking (e.g., based on popularity or other metrics). The fine-tuned LLM system is also advantageously able to refine proposed test scenario rankings based on user selection, and to adjust test scenario proposals for subsequent runs. The fine-tuned LLM system in some embodiments is further configured to detect missing test units and notify users accordingly.

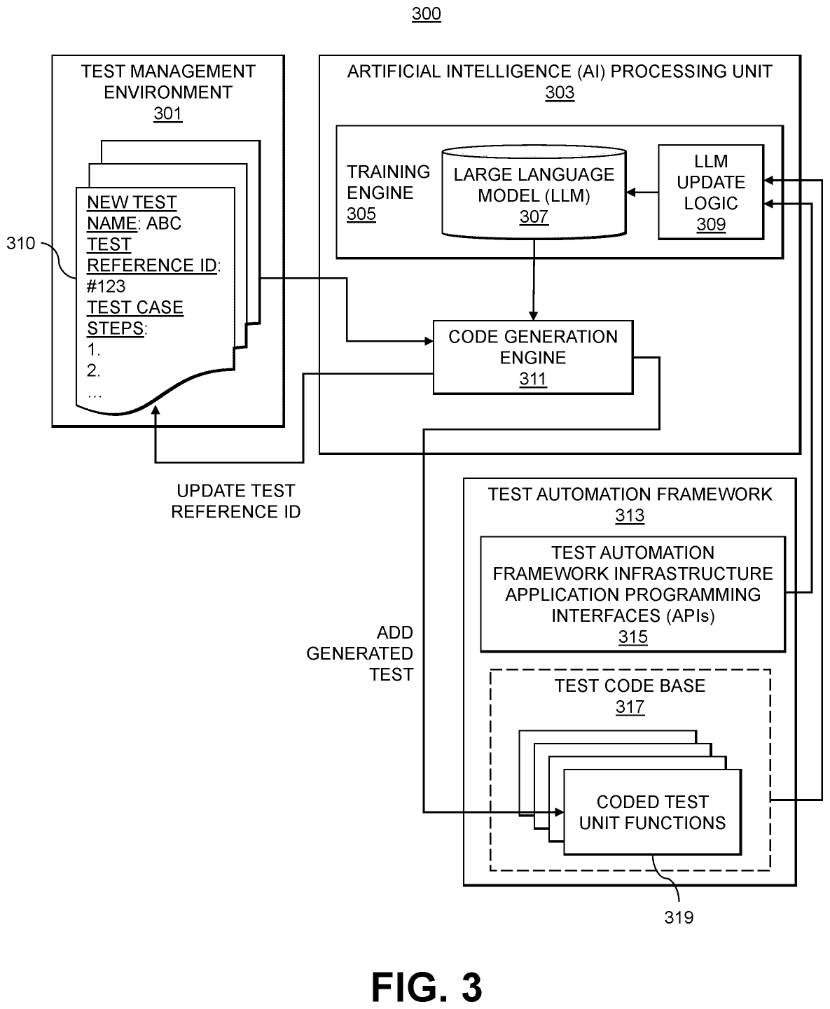

FIG. 3 shows a system 300 configured for generation of test scenarios, including a test management environment 301, an artificial intelligence (AI) processing unit 303 and a test automation framework 313. The test management environment 301 and the test automation framework 313 provide input data used to feed the LLM 307. The test management environment 301 includes a database of test steps and test scenarios 310, and the test automation framework 313 includes one or more test automation framework infrastructure APIs 315 and an existing test code base 317 that includes code for discrete test steps or primitives that can be used to create new test scenarios as well as full existing test case scenarios which help to train the LLM 307 to help generate more precise outputs.

The AI processing unit 303 includes a training engine 305 configured for training the LLM 307 utilizing LLM update logic 309. The AI processing unit 303 also includes a code generation engine 311. The code generation engine 311 is configured to utilize the trained LLM 307 to translate test steps and test scenarios 310 in the test management environment 301 into corresponding API calls which may be submitted to the test automation framework infrastructure APIs 315 of the test automation framework 313. The API calls may include validation and verification of the status before and after each one of the test steps (or after some designated group of test steps), and specific validation and verification APIs are added to the test automation framework infrastructure APIs 315 as part of the translations. The training engine 305 utilizes the LLM update logic 309 to consistently update the LLM 307 with new test steps that are mapped to the test automation framework infrastructure APIs 315. The AI processing unit 303 is further configured to display proposed test scenarios for user selection, and pass the selected test scenarios to the training engine 305 to refine the LLM update logic 309. The AI processing unit 303 is configured to utilize the fine-tuned LLM 307 to map test steps to respective coded test unit functions 319 which are persisted in the test code base 317 of the test automation framework 313. Test scenarios generated by the code generation engine 311 utilizing the fine-tuned LLM 307 are also persisted in the test management environment 301.

The training engine 305 is configured to learn all existing test steps and test scenarios 310 in the test management environment 301, and uses the LLM update logic 309 to train and fine-tune the LLM 307 to propose acceptable and reasonable test scenarios to a requestor based on the learning. Several test scenarios can be proposed with a rating, and based on the user selection and as a result, the training of the LLM 307 can be refined. In some embodiments, the training engine 305 is configured to train and fine-tune the LLM 307 to learn a precise test order, to find gaps in test scenarios, and to rank test scenarios. For learning the precise test order, consider an example of a first existing test step of cabling, where “disconnect cable X from server Y” is translated to one or more coded test unit function API calls with verifications and validations before and/or after the action. Similarly, a second existing test step of “reconnecting the cable X back to the server Y” is translated to one or more coded test unit function API calls with verifications and validations before and/or after the action. The training engine 305 is configured to learn that the reasonable scenario is to perform the first existing test step (e.g., “disconnect cable X from server Y”) prior to the second existing test step (e.g., “reconnecting the cable X back to the server Y”). Therefore, if the first and second existing test steps in an instruction are not according to the learned reasonable order, an alert is presented with a request to approve the order exception. For finding gaps in test scenarios, consider an example of an instruction to create a test scenario of booting a server. It is possible to suggest enhancing the test by using a test bed with a server that runs under an extremely high input-output (IO) request rate, adding clone operations that will run in the background, etc. These and other suggestions may be derived from other test scenarios. For ranking test scenarios, consider an example of an instruction to create an object. Several test scenarios may be proposed, with a rating or ranking of the proposed test scenarios. The ratings or rankings may be based on popularity and frequency of use (e.g., of similar existing test scenarios). The user can choose the proposed test scenario most proper for that user's needs, with the option to consider the ratings or rankings of the proposed test scenarios.

In some embodiments, a few-shot prompting approach is utilized for fine-tuning the LLM 307. Test steps are used to find similar or related tests in the database of the test management environment 301, and are supplied as added inputs (e.g., shots) to the LLM 307 when a request is issued for creating a new test scenario. This allows the LLM 307 to focus on a desired result and increase the precision of the final output.

The code generation engine 311 is configured to process instructions (e.g., a request for creating a new test scenario, possibly along with few-shot prompting as described above) in order to generate the requested test scenario, which is added to the test automation framework 313 and is kept in the test management environment 301 with a test reference identifier (ID) (e.g., a mapping between test steps of the new test scenario and ones of the coded test unit functions 319 in the test code base 317 of the test automation framework). In the case where the LLM 307 is not able to understand a part of the instructions, or if the test code base 317 of the test automation framework 313 does not include necessary coded test unit functions (e.g., existing framework functionality is missing), one or more notifications are generated to indicate that the missing functionality needs to be added (e.g., a test step in the test management environment 301 and a corresponding coded test unit function in the test code base 317 of the test automation framework 313).

By using the existing test units and test scenarios in the test management environment 301 for a specific project or product, the LLM 307 is able to use a pre-defined context that sets a limit on the total number of the created tokens, each representing a test step in a test scenario that is mapped to a test unit function API or APIs as described above. This safeguards the output of the LLM 307 and increases the precision as well. To deal with suboptimal method precision, especially during the learning time, it may happen that a user will receive several options for the same instruction. In such cases, the user is prompted with all options and the frequency of each one (e.g., in other test scenarios) and chooses the suitable one. This is used as feedback for training the LLM 307. By doing this, the LLM 307 may be continually re-trained. Further, the LLM 307 is trained by adding the created test scenario to the existing test code base 317 and the test management environment 301, which provides fine-tuning of a question-answering model like the LLM 307.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine-learning based generation of test scenarios will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100 in FIG. 1. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine-learning based generation of test scenarios as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to generate a first data structure by parsing a request to generate a given test scenario for testing of an information technology asset;
to process the first data structure utilizing a machine learning model to generate a second data structure, the second data structure comprising a given sequence of test steps for the given test scenario;
to map the given sequence of test steps in the second data structure to respective application programming interface calls of a test automation framework, each of the application programming interface calls being associated with a functional code test unit of a test code database of the test automation framework; and
to execute the given test scenario utilizing the mapped application programming interface calls of the test automation framework.

2. The apparatus of claim 1 wherein the request to generate the given test scenario comprises a natural language description of a testing goal for the given test scenario.

3. The apparatus of claim 1 wherein generating the first data structure comprises selection of one or more test steps from a test management environment comprising a repository of one or more existing test scenarios and associated test steps.

4. The apparatus of claim 3 wherein generating the first data structure comprises selecting at least one of one or more existing test scenarios from a repository of the test management environment.

5. The apparatus of claim 4 wherein processing the first data structure utilizing the machine learning model comprises utilizing the selected at least one existing test scenario for adapting the machine learning model to a testing context of the selected at least one existing test scenario.

6. The apparatus of claim 1 wherein the machine learning model comprises a large language model.

7. The apparatus of claim 1 wherein processing the first data structure utilizing the machine learning model comprises generating two or more different sequences of test steps as alternatives for the given test scenario.

8. The apparatus of claim 7 wherein generating the second data structure comprises:
presenting the two or more different sequences of test steps to a source of the request to generate the given test scenario;
selecting one of the two or more different sequences of test steps based at least in part on feedback received from the source of the request to generate the given test scenario; and
adding the selected one of the two or more different sequences of test steps as the given sequence of test steps in the second data structure.

9. The apparatus of claim 8 wherein generating the second data structure further comprises determining a ranking of the two or more different sequences of test steps and providing the determined ranking of the two or more different sequences of test steps to the source of the request to generate the given test scenario.

10. The apparatus of claim 9 wherein the ranking of the two or more different sequences of test steps is determined based at least in part on frequencies of use of test steps in the two or more different sequences of test steps in a set of one or more existing test scenarios of a test management environment.

11. The apparatus of claim 1 wherein the second data structure further comprises specification of one or more test bed characteristics of a test bed to be utilized for executing the given test scenario.

12. The apparatus of claim 11 wherein the one or more test bed characteristics comprises at least one of a hardware and a software configuration for the test bed to be utilized for executing the given test scenario.

13. The apparatus of claim 11 wherein the one or more test bed characteristics comprises one or more workloads to run on the test bed during execution of the given test scenario.

14. The apparatus of claim 1 wherein at least a given one of the application programming interface calls of the test automation framework associated with a given functional code test unit comprises at least one of a validation and a verification of a given one of the test steps to be performed at least one of prior to and subsequent to execution of the given functional code test unit.

15. A computer program product comprising a non-transitory processor-readable storage medium having stored therein program code of one or more software programs, wherein the program code when executed by at least one processing device causes the at least one processing device:
to generate a first data structure by parsing a request to generate a given test scenario for testing of an information technology asset;
to process the first data structure utilizing a machine learning model to generate a second data structure, the second data structure comprising a given sequence of test steps for the given test scenario;
to map the given sequence of test steps in the second data structure to respective application programming interface calls of a test automation framework, each of the application programming interface calls being associated with a functional code test unit of a test code database of the test automation framework; and
to execute the given test scenario utilizing the mapped application programming interface calls of the test automation framework.

16. The computer program product of claim 15 wherein the machine learning model comprises a large language model.

17. The computer program product of claim 15 wherein generating the first data structure comprises selecting at least one of one or more existing test scenarios from a repository of a test management environment, and wherein processing the first data structure utilizing the machine learning model comprises utilizing the selected at least one existing test scenario for adapting the machine learning model to a testing context of the selected at least one existing test scenario.

18. A method comprising:
generating a first data structure by parsing a request to generate a given test scenario for testing of an information technology asset;
processing the first data structure utilizing a machine learning model to generate a second data structure, the second data structure comprising a given sequence of test steps for the given test scenario;
mapping the given sequence of test steps in the second data structure to respective application programming interface calls of a test automation framework, each of the application programming interface calls being associated with a functional code test unit of a test code database of the test automation framework; and
executing the given test scenario utilizing the mapped application programming interface calls of the test automation framework;
wherein the method is performed by at least one processing device comprising a processor coupled to a memory.

19. The method of claim 18 wherein the machine learning model comprises a large language model.

20. The method of claim 18 wherein generating the first data structure comprises selecting at least one of one or more existing test scenarios from a repository of a test management environment, and wherein processing the first data structure utilizing the machine learning model comprises utilizing the selected at least one existing test scenario for adapting the machine learning model to a testing context of the selected at least one existing test scenario.
